(19) United States
(12) Patent Application Publication
(10) Pub. No.: US 2024/0060303 A1
(43) Pub. Date: Feb. 22, 2024

(54) MULTI-MATERIAL SHEATHING SYSTEM

(71) Applicant: Owens Corning Intellectual Capital, LLC, Toledo, OH (US)

(72) Inventors: Hai FU, Pataskala, OH (US); Shu SITU-LOEWENSTEIN, Lake Elmo, MN (US); Xiaomin GUO, New Albany, OH (US)

(21) Appl. No.: 18/452,148

(22) Filed: Aug. 18, 2023

Related U.S. Application Data
(60) Provisional application No. 63/510,815, filed on Jun. 28, 2023.
(60) Provisional application No. 63/385,158, filed on Nov. 28, 2022.
(60) Provisional application No. 63/383,689, filed on Nov. 14, 2022.
(60) Provisional application No. 63/399,546, filed on Aug. 19, 2022.

(51) Int. Cl. E04C 2/24; B32B 27/08; B32B 27/20; B32B 27/30; B32B 27/36; B32B 27/40; B32B 21/02; B32B 21/08; E04B 2/00

(52) U.S. Cl. CPC E04C 2/243; B32B 27/08; B32B 27/20; B32B 27/302; B32B 27/365; B32B 27/40; B32B 21/02; B32B 21/08; E04C 2/46; B32B 2607/00; B32B 2307/304; B32B 2307/7376; B32B 2250/03; B32B 2250/40; B32B 2250/24; B32B 2307/718; B32B 2307/302

(57) ABSTRACT

A sheathing system that envelops a building structure is provided, combining lightweight structural layers and a high R-value insulation layer to provide a unique solution. The collective layers of the sheathing system offer the benefits of decreased thickness, reduced weight, improved thermal insulation, improved structural strength, improved nailability, improved fire and smoke performance, and enhanced energy efficiency. All aspects of the disclosed sheathing system can contribute to the overall improved performance and sustainability of a building structure.

### CROSS-REFERENCE TO RELATED APPLICATIONS

This application claims priority to U.S. Provisional Application Ser. No. 63/510,815, filed on Jun. 28, 2023; U.S. Provisional Application Ser. No. 63/385,158, filed on Nov. 28, 2022; U.S. Provisional Application Ser. No. 63/383,689, filed on Nov. 14, 2022; and U.S. Provisional Application Ser. No. 63/399,546, filed on Aug. 19, 2022, the entire contents of each being incorporated by reference herein.

### TECHNICAL FIELD

Aspects hereof relate to a layered building product, and more specifically a sheathing system for use in building construction. The sheathing system disclosed herein comprises layered panels having both structural and insulative properties.

### BACKGROUND

In contemporary building construction, wall sheathing systems are employed to provide structural support, insulation, and protection against external environmental factors. Conventional wall sheathing materials, such as plywood and oriented strand board (OSB), have been widely used and are typically seen as capable of providing structural support or rigidity to a structure; however, these materials generally lack sufficient thermal insulation properties. Among other shortcomings, the inadequate insulating properties of conventional sheathing translates into greater energy expenditures to maintain the temperature and humidity levels of conditioned spaces.

To address the insulation challenge, traditional practice involves the application of separate insulation layers in conjunction with conventional wall sheathing materials. While this approach can enhance energy efficiency, it adds complexity to the construction process and increases material and labor costs. In addition to its limited ability to insulate, conventional wall sheathing materials are also susceptible to moisture infiltration and degradation over time, which can compromise both the structural integrity and thermal performance of the building envelope. To address the moisture problem, conventional building practices call for wrapping sheathing with a water-resistant wrap. Applying wrap is a labor-intensive task, which can increase labor and material costs. Moreover, wraps are generally susceptible to being displaced during construction and can trap moisture between the wrap and sheathing.

### BRIEF SUMMARY

The present disclosure is directed to a high strength but lightweight multi-material sheathing system that, when utilized to envelope at least a portion of a building structure, provides enhanced thermal insulation and weather resistant properties. The disclosed wall sheathing system combines lightweight structural layers and a high R-value insulation layer to provide a unique solution. Embodiments of the present disclosure relate to a sheathing system that utilizes one or more thin layers of strong yet lightweight material, combined with a high R-value insulation layer. The collective layers of the sheathing system offer the benefits of decreased thickness, reduced weight, improved thermal insulation, improved structural strength, improved nailability, improved fire and smoke performance, and enhanced energy efficiency. All aspects of the disclosed sheathing system can contribute to the overall improved performance and sustainability of a building structure.

In accordance with aspects herein disclosed, a sheathing system is provided that includes one or more structural layers and an insulation layer. The structural layer comprises a polycarbonate material and has a first surface and an opposing second surface. In an exemplary aspect, the structural layer is substantially bulk water resistant and substantially water vapor permeable. The insulation layer comprises an extruded polystyrene and has a third surface and an opposite fourth surface. The third surface of the insulation layer is secured to the second surface of the structural layer. In some further aspects, the sheathing system also comprises an additional structural layer comprising the polycarbonate material and having a fifth surface and an opposing sixth surface. The fifth surface of the additional structural layer can be at least partially secured to the fourth surface of the insulation layer.

In accordance with the disclosed aspects, the sheathing system weighs less than conventional systems with a weight between 10 to 45 pounds, has a thickness of no greater than 1.5 inches, preferably a thickness no greater than one inch, and has an R-value of at least 3.5, preferably an R-value of at least 4.5. Thus, the disclosed sheathing system is superior to conventional systems, which are generally heavier, thicker, and have a lower R-value.

This summary is provided to introduce and not limit the scope of methods and systems provided hereafter in complete detail.

### DESCRIPTION OF THE DRAWINGS

The present invention is described in detail herein with reference to the attached drawing figures, wherein:

FIG. 1A depicts a perspective view of a three-dimensional sheathing system, in accordance with aspects hereof;

FIG. 1B depicts an exploded view of a three-dimensional sheathing system, in accordance with aspects hereof;

FIG. 2A depicts a cross-sectional view of a three-dimensional sheathing system, in accordance with aspects hereof;

FIG. 2B depicts a cross-sectional view of a three-dimensional sheathing system, in accordance with aspects hereof;

FIG. 3A depicts a perspective view of a three-dimensional sheathing system, in accordance with aspects hereof;

FIG. 3B depicts an exploded view of a three-dimensional sheathing system, in accordance with aspects hereof;

FIG. 4 depicts a cross-sectional view of a three-dimensional sheathing system, in accordance with aspects hereof;

FIG. 5 depicts a cross-sectional view of a three-dimensional sheathing system, in accordance with aspects hereof;

FIG. 6 depicts a cross-sectional view of a three-dimensional sheathing system, in accordance with aspects hereof;

FIG. 7 depicts a cross-sectional view of a three-dimensional sheathing system, in accordance with aspects hereof;

FIG. 8 depicts a cross-sectional view of a three-dimensional sheathing system, in accordance with aspects hereof;

FIG. 9A depicts a perspective view of a three-dimensional sheathing system, in accordance with aspects hereof;

FIG. 9B depicts a cross-sectional view of a three-dimensional sheathing system, in accordance with aspects hereof;

FIG. 10A depicts a cross-sectional view of a three-dimensional sheathing system, in accordance with aspects hereof;

FIG. 10B depicts a cross-sectional view of a three-dimensional sheathing system, in accordance with aspects hereof;

FIG. 11A through FIG. 11G depict exemplary physical data, in accordance with aspects hereof;

FIG. 12A through FIG. 12D depict exemplary physical data, in accordance with aspects hereof; and

FIG. 13A through FIG. 13D depict exemplary physical data, in accordance with aspects hereof.

### DETAILED DESCRIPTION

Unless defined otherwise, all technical and scientific terms used herein have the same meaning as commonly understood by one of ordinary skill in the art to which the embodiments belong. Although any methods and materials similar or equivalent to those described herein can be used in the practice or testing of the various embodiments, the preferred methods and materials are described herein. In the drawings, the thickness of the lines, layers, and regions can be exaggerated for clarity. It is to be noted that like numbers found throughout the figures denote like elements.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that can vary depending upon the desired properties sought to be obtained by the present exemplary embodiments. At the very least, each numerical parameter should be construed in light of the number of significant digits and ordinary rounding approaches.

Unless otherwise indicated, any element, property, feature, or combination of elements, properties, and features, can be used in any embodiment disclosed herein, regardless of whether the element, property, feature, or combination of elements, properties, and features was explicitly disclosed in the embodiment. It will be readily understood that features described in relation to any particular aspect described herein can be applicable to other aspects described herein provided the features are compatible with that aspect.

Every numerical range given throughout this specification and claims will include every narrower numerical range that falls within such broader numerical range, as if such narrower numerical ranges were all expressly written herein.

The term “R-value” is the unit used to measure the effectiveness of thermal insulation and is the reciprocal of thermal conductivity, which for foam board materials having substantially parallel faces, is defined as the rate of flow of thermal energy (BTU/hr. or Watt) per unit area (square foot, i.e. ft² or square meter, i.e. m²) per degree of temperature difference (Fahrenheit or Kelvin) across the thickness of the slab material (inches or meters). The thermal performance of a polymeric insulation product is based on the R-value of the insulation product, which is a measure of the product's resistance to heat flow. The R-value is defined by Equation (1):

R=T/k

where “T” is the thickness of the insulation product expressed in inches, “k” is the thermal conductivity of the insulation product expressed in BTU·in/hr·ft²·° F., and “R” is the R-value of the insulation expressed in hr·ft²·° F./BTU.

As used herein, an insulation product's thickness (T) can be determined in accordance with ASTM C167-18 and both k-value and area weight (in lb/ft²) can be determined in accordance with ASTM C518-21 or ASTM C177-19.

The following describes select aspects relating to a sheathing system for use in constructing a building structure (e.g., a residential home, a commercial building, an industrial building). The disclosed sheathing system can comprise panels capable of being attached to a frame of a building structure, thereby forming a sheath that envelopes at least a portion of the building structure. The sheath formed by the disclosed sheathing system can correspond to a wall portion (e.g., vertical surface) or a roofing portion of the building structure, by way of example.

The multi-material sheathing system disclosed herein provides for various improvements over conventional sheathing systems. The unique collection of individual layers (also referenced herein as “components”) utilized in the production of the disclosed sheathing system provide for a stronger, thinner, and lighter sheathing panel having a higher R-value per inch of total thickness, which offers several advantages over conventional sheathing systems.

The materials used in the novel sheathing system herein provide a thinner structural layer that maintains or exceeds the structural performance of conventional systems. As one of ordinary skill in the art can appreciate, thinner materials generally take up less space within the building envelope, allowing for more efficient utilization of interior space. This can be especially crucial in applications where maximizing usable area is essential, such as in residential homes or commercial buildings. Thinner materials are also generally lighter in weight, which can simplify handling, transportation, and installation. Additionally, the utilization of alternative materials for sheathing systems, as will be described, greatly reduces weight. Reduced weight can also have positive implications for the structural load on the building's foundation and framing. Thin materials provide architects and builders with greater flexibility in designing and implementing various architectural elements, such as curves, angles, and intricate details. This can also lead to faster construction times due to easier handling and installation. The thin materials can subsequently result in reduced labor costs and faster project completion.

The materials utilized and described herein provide an insulated sheathing system with a high R-value. The higher the R-value, the more effective insulative characteristics are attributed to the sheathing system. More specifically, a sheathing system with a high R-value generally indicates that the sheathing system is effective at reducing heat flow through walls, roofs, and floors. This translates to lower energy consumption for heating and cooling, lower utility bills and a smaller carbon footprint. High R-value sheathing systems also help maintain more consistent indoor temperatures by reducing drafts, cold spots, and heat loss, further providing occupants with a comfortable living or working environment year-round. As is generally known in the building industry, minimum insulation R-values on external sheathing of a building structure may be required by code. In this regard, conventional sheathing systems may require a builder add insulation after a sheathing panel is affixed to the building structure in order to obtain the adequate R-value, further complicating the construction process and leading to additional resource expenditures.

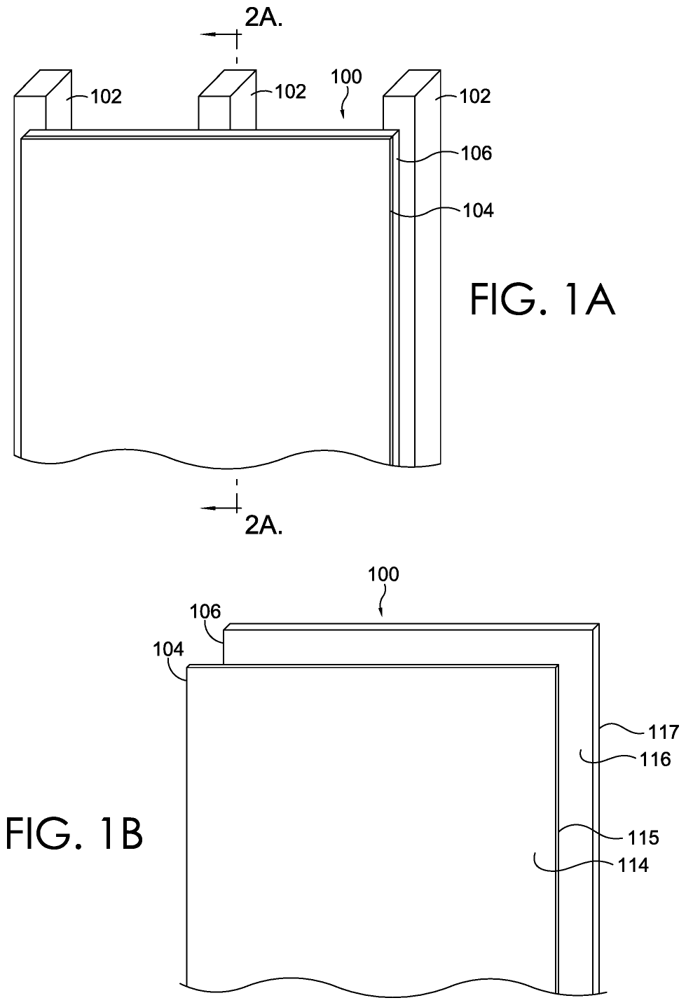

Turning to FIG. 1A and FIG. 1B, examples of a sheathing system for externally enveloping at least a portion of a building structure are illustrated in accordance with an exemplary aspect hereof. FIG. 1A depicts a sheathing system 100 joined to a building frame structure 102. The sheathing system 100 comprises a structural layer 104 and an insulation layer 106 (i.e., a “2-layer system”). As seen in FIG. 1B, the structural layer 104 comprises a first surface 114 and a second surface 115 opposite the first surface 114. The structural layer 104 can have a thickness measured as a distance from the first surface 114 to the second surface 115 opposite the first surface 114. The insulation layer 106 comprises a third surface 116 and a fourth surface 117 opposite the third surface 116. A thickness of the insulation layer 106 can be measured as a distance from the third surface 116 to the fourth surface 117.

The sheathing system 100 is formed by coupling the second surface 115 of the structural layer 104 to the third surface 116 of the insulation layer 106, wherein the sheathing system 100 has an overall thickness of a distance measured from the first surface 114 to the fourth surface 117. More specifically, the structural layer 104 can be coupled to the insulation layer 106 by bonding, adhering, applying, or mechanically fastening one layer to the other. By way of example, the sheathing system 100 can be formed by applying a glue layer to the second surface 115 of the structural layer 104 or the third surface 116 of the insulation layer 106 and adhering one surface to the other. In some embodiments, the glue layer can have a weight range from about 4.885 gm/cm² (1 lbs./MSF) to about 244.5 gm/cm² (50 lbs./MSF). The glue layer can comprise any variety of adhesive, such as a resin (e.g., phenol-formaldehyde, polyvinyl acetate), hot-melt, isocyanate-based adhesive, tar, or other adhesives, by way of non-limiting example.

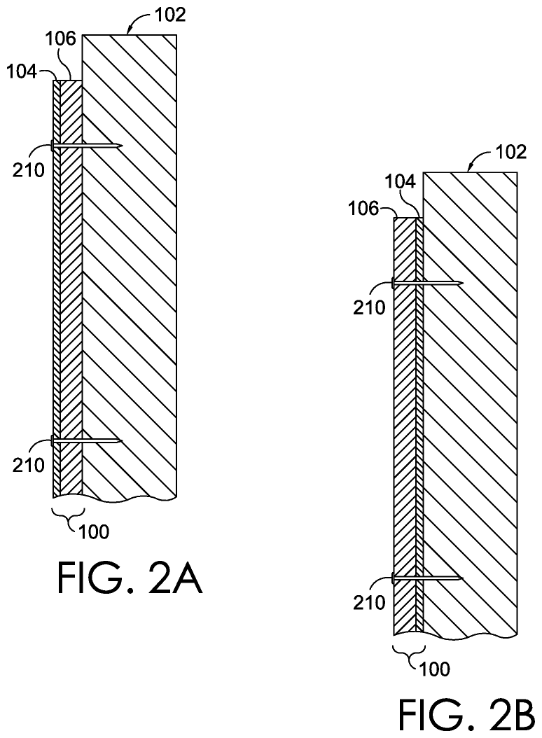

Continuing with FIGS. 2A-2B, different arrangements for coupling the sheathing system 100 to the building frame structure 102 are illustrated. Turning to FIG. 2A, a cross-sectional view of the sheathing system 100 of FIG. 1A, is depicted along a cutline (2A. of FIG. 1A). The configuration shown in FIG. 2A contemplates that the sheathing system 100 has the insulation layer 106 adjacent the building frame structure 102. The configuration shown in FIG. 2B contemplates that the sheathing system 100 has the structural layer 104 adjacent the building frame structure 102. The sheathing system 100 can be fastened to the building frame structure 102 by use of a fastener 210. A fastener 210 can comprise any variety of fastener, such as a nail, screw, bolt, adhesive, anchor, rail molding, cleat, magnet, pegboard, suction, hook and loop, or any other suitable fastener generally known in the art.

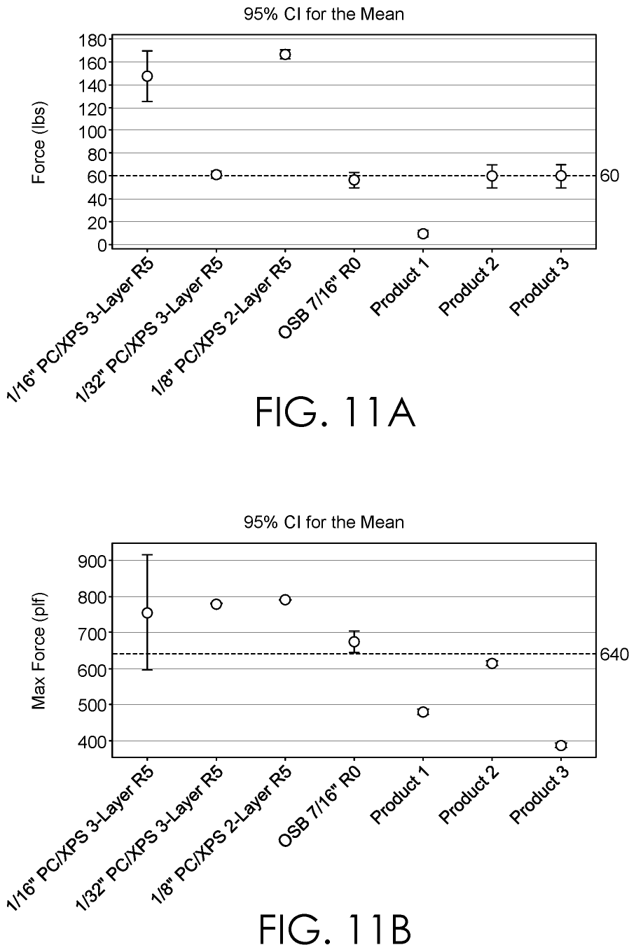

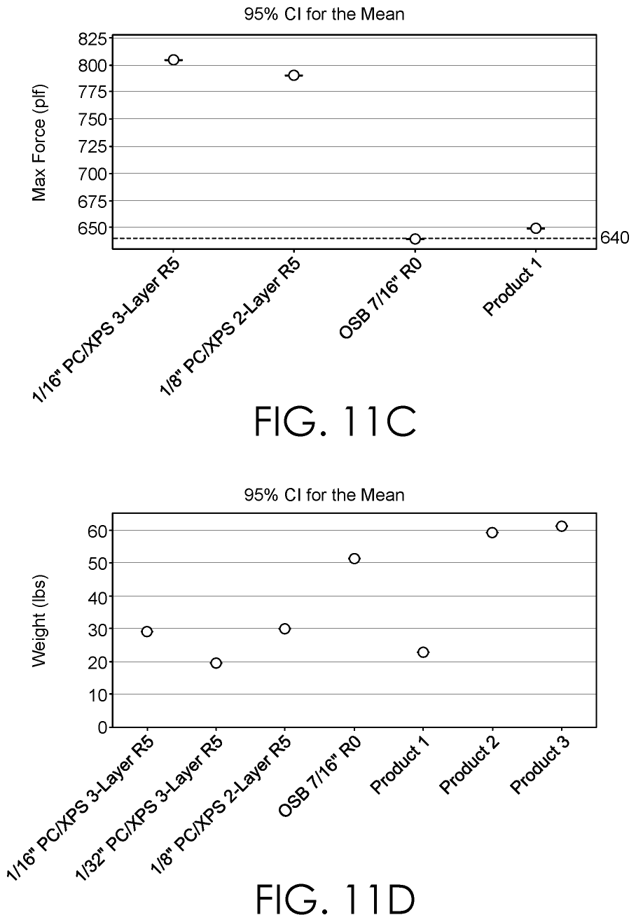

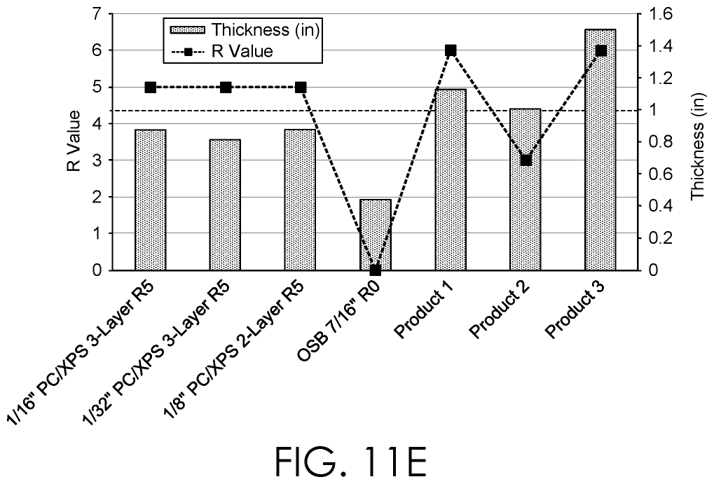

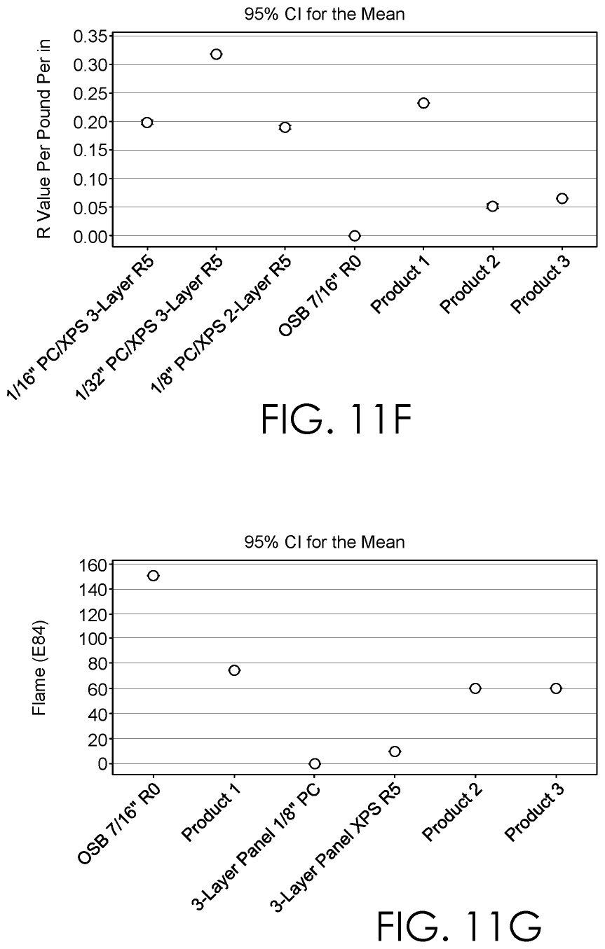

The fastener 210 can be used to secure the sheathing system 100 to the building frame structure 102. It is preferable that the sheathing system 100 provides resistance such that the fastener 210 is prevented from being withdrawn from the sheathing system 100. The sheathing system 100 comprises a unique layered panel system with specific materials chosen for each layer. The materials chosen for each layer leads to the sheathing system 100 meeting or exceeding current industry standard sheathing systems with respect to nail withdrawal force. For example, in an exemplary embodiment, the sheathing system 100 can be comprised of a panel having a ⅛ inch thick structural layer 104 comprised of polycarbonate material. The use of a polycarbonate as the structural layer 104 gives the sheathing system 100 an ability to resist nail withdrawal better than industry standard sheathing systems. With brief reference to FIG. 11A, embodiments described herein meet or exceed industry standard products. The 2-layer system shown in FIG. 11A has a thickness of ⅞ inch and a nail withdrawal force of greater than 160 lbs. or 180 lbs. per inch as measured in accordance with ASTM D1037 standards. The 2-layer system is comprised of a polycarbonate structural layer 104 and an insulation layer 106 comprising extruded polystyrene (XPS). In comparison, an industry standard wall sheathing comprised of oriented strand board (OSB) at a thickness of 7/16 inch has a nail withdrawal force of 60 lbs., or 137 lbs. per inch.

Continuing with FIGS. 2A and 2B, different thicknesses of the sheathing system 100 are described and can vary based on its intended use. In implementations where better insulating properties are desirable, the overall thickness of the sheathing system 100 can be greater. For example, the sheathing system 100 can have an R-value of 10 when the overall thickness of the sheathing system 100 is two inches. In implementations where lower insulative properties is acceptable, the sheathing system 100 can have an overall thickness of one inch or less while still preserving an R-value of at least 3.5. One skilled in the art will appreciate that many other thicknesses can be used (e.g., the sheathing system 100 can have an R-value of 7 when the overall thickness is 1.5 inches), though the overall thickness of the sheathing system 100 is preferably in the range of 0.5-2 inches. It is contemplated that values beyond that range for the overall thickness can be used depending on the partner needs of a project. As with conventional sheathing solutions, the R-value of the sheathing system 100 increases with its overall thickness. Accordingly, the sheathing system 100 can have an R-value ranging at least from 3.5 to 10. In various embodiments, the total R-value of the sheathing system can vary depending on the proportion of the insulation layer 106 to the structural layer 104.

As noted above, the proportion of thickness of structural layer 104 to the thickness of insulation layer 106 can vary based on the particular needs of a project. For example, when greater structural strength is desired in areas prone to high winds or seismic forces, one may want to increase the relative structural thickness. In a further example, when greater insulation is desired and strength can be sacrificed, such as in less temperate climates, one may want to increase the relative thickness of the insulation layer. In a preferred arrangement, the ratio of insulation layer 106 thickness to structural layer 104 thickness is about 3:1. As an example, a sheathing system having a 3:1 ratio and an overall thickness of 1 inch would have ¼ inch structural layer 104 and ¾ inch insulation layer 106. In other exemplary embodiments, the ratio of insulation layer 106 thickness to structural layer 104 thickness can be 6:1, 5:1, 4:1, 2:1, 1.5:1, or 1:1, by way of non-limiting example. Additional ratios not disclosed herein are considered within the purview of the present disclosure.

The structural layer 104 can have a variety of thicknesses based on structural needs of the building. By way of example, the structural layer 104 can have a thickness of ⅛ inch. Additionally, the structural layer can have a thickness in a range of 1/64 inch and 1 inch. To accommodate the differing insulation needs described above, the insulation layer 106 can have a thickness in a range of ¼ inch and 1½ inches. As such, the combined thickness of the structural layer 104 and the insulation layer 106 can be in a range of ½ inch and 2 inches. In an exemplary configuration, the thickness of the structural layer 104 and the insulation layer 106 is equal to or less than 1 inch, having an R-value of 3.5 or greater. In another exemplary configuration, the thickness of the structural layer 104 and the insulation layer 106 is equal to or less than 1 inch, having an R-value of 5 or greater. Furthermore, alternative embodiments have an R-value-to-thickness ratio of at least 5, resulting in a 2-inch system with an R-value of 10.

As described herein, the purpose of the insulation layer 106 is to provide enhanced thermal resistance. The insulation layer 106 of the sheathing system 100 can comprise materials selected to have a high R-Value. In one exemplary embodiment, the insulation layer comprises extruded polystyrene (XPS). It is contemplated that insulation layer 106 can comprise any insulating material, including but not limited to fiberglass, wood, foam, polymers, wood composite materials, expanded polystyrene (EPS), foamed polyurethane, polyisocyanurate board, fiber-reinforced polymer, thermoplastic, polymer-based materials, mineral wool, closed cell thermoplastic, thermoplastic polystyrene, polyethylene terephthalate, polyester resin, phenolic foam, aerogel blanket, aerogel board, cellulosic insulation, rock wool insulation, or any combination thereof. Polymer-based insulation materials, which can also or alternatively be utilized in insulation layer 106, can include polyurethane, phenolic foam, TPO, thermoplastic polyolefin (TPO), and ethylene propylene diene monomer (EPDM), among other things.

On the other hand, the structural layer 104 provides rigidity and structural support to the envelope of the building structure. Accordingly, the structural layer 104 can be comprised of any one or more materials that resist kinetic forces, such as polycarbonate or composites. Additional materials that can provide the rigidity and structural support that the structural layer 104 requires can be one or more of materials such as polypropylene, high density polyethylene (HDPE), or a wood composite. Structural layer 104 can comprise a polymer, polycarbonate, stainless steel, glass, polyester, polypropylene, polyethylene, acrylic, acrylonitrile styrene acrylate, cyclic olefin copolymer, polycyclohexylenedimethylene terephtalate, polyether ketone, polyaryletherketones, polyetherimide, polyethersulfone, polymethyl methacrylate, poly vinyl chloride, polyphthalmide, polyphenylene oxide, polyphenylene sulfide, recycled HDPE, any recycled plastic or polymer, polysulfone, or syndiotactic polystyrene. The polymer can comprise one or more of poly vinyl styrene, plexiglass, high density polypropylene (HDPP), hard plastic, soft plastic, polyethylene terephthalate, acrylonitrile butadiene styrene, thermoplastic, thermosets, elastomer, hemp, shellac, amber, wool, silk, natural rubber, cellulose, silicone, polybutylene terephthalate, styrene-butadiene rubber, or other polymers or co-polymers. In a further example, recycled materials, including recycled polycarbonate, can be used for the structural layer 104. Additionally, other recycled materials can also be considered for the structural layer 104, such as recycled plastics or composite materials made from reclaimed wood fibers and plastic.

In other aspects, the structural layer 104 can comprise a polymer composite formed from a polymer and at least one filler material. The addition of a filler material can add desired physical properties to the structural layer 104, such as texture, color, strength, reduced weight, or other physical properties. The polymer composite can comprise a filler material that is added to the polymer in a ratio by weight of between 1 percent by weight and 90 percent filler material to polymer. In further aspects, the filler material can comprise any amount of a powder, talc, calcium carbonate, calcium carbonate pellets, cellulose, sand, silica, magnesium oxide, aluminum oxide, clay, inorganic powder, a colorant, ground tire rubber, rubber, calcium sulfate, calcium silicate, barium sulfate, mica, kaolin, silicone dioxide, diatomaceous earth, minerals, fibrous glass, carbon fibers, glass, polymer beads, magnesium hydroxide, fly ash, polymer foam beads, masonry filler, wollastonite, short glass fibers, long glass fibers, glass beads, coal, dolomite, carbon black, silica, magnetite, hematite, halloysite, zinc oxide, titanium dioxide, Al(OH)₃, Mg(OH)₂, concrete gravel, stone, sand, steel, aluminum, or any other material that can be added to the polymer of the structural layer 104. In alternative embodiments, organic filler, rice hulls, nut flour, wood flour vegetable fibers, cotton fiber, starch, synthetic organic tiller, rubber particles, chalk, quartz, granite, alumino-silicates, vermiculite, nepheline-senite, barium ferrite, barium titanate, molybdenum disulphide, potassium titanate, metal oxides, metal hydrates, metal powder, zinc, beryllium oxide, blowing agent, PBT, ceramics, or other materials that can be added to the polymer, can be used as the filler material. In another embodiment, glass fibers, carbon fibers, mineral fillers (e.g., calcium carbonate, talc, or mica), aramid fibers, glass beads, nanoclays, metal particles, natural fibers (e.g., hemp, jute, or flax), graphene, rubber particles, ceramic fillers (e.g., alumina or silica), recycled materials (e.g., plastic or rubber materials), wood fibers/flour, conductive fillers (e.g., carbon black or metal powders), flame retardant fillers (e.g., phosphorus-based compounds or halogenated additives) can be contemplated for use as the filler material.

In some embodiments, the filler material can have a size of up to 1 mm. The polymer composite can have filler material comprised of variously-sized substances from 1 micron to 1000 microns, 1 micron to 1 centimeter, or 10 mesh to 100 mesh, by way of non-limiting example. In an embodiment, the filler material can be added to the polymer in a ratio of 1 percent by weight up to 90 percent by weight of the polymer. In another embodiment, a ratio of between 30 percent by weight and 60 percent by weight of the polymer can be used for the filler material.

The sheathing system 100 can be milled or shaped into any desirable shape or size. Formed as a planar sheet (i.e. panel) in any one or more standard sizes (e.g., 1.319 m×2.438 m (4 ft.×8-ft.), 1.319 m×3.048 m (4 ft.×10 ft.), or 1.319 m×3.658 m (4 ft.×12 ft.)), the sheathing system 100 can be shaped or cut according to specific dimensions and/or design requirements (e.g., different geometric shapes). Using cutting or shaping tools available on a worksite (e.g., a circular saw) or precision tooling (e.g., a Computer Numerical Control (CNC) machine), each layer of the sheathing system 100 can be cut or milled accordingly.

In an additional embodiment, the structural layer 104 can resist racking forces and exceed ASTM E72 industry standards for structural wall sheathing systems. The ASTM E72 standards determine the ability of the sheathing system 100 to deflect static load (i.e., resist racking). The resistance to racking for particular embodiments is described in further detail with respect to FIG. 11B. For example, in one embodiment, the sheathing system 100 can have the racking strength max force of greater than 640 pounds per linear foot (plf) according to the ASTM E72 test, which is greater than or equal to standard systems in the industry.

The structural layer 104 can be resistant to bulk water but permeable to water vapor. The structural layer 104 can be characterized by water vapor permeance in a range from about 0.1 U.S. perms to about 1.0 U.S. perms, and have a water vapor transmission rate from about 0.07 to about 7 g/m²/24 hr. (at 73° F.-50% RH via ASTM E96 procedure A). Additional embodiments of the structural layer 104 have a water vapor permeance from about 0.1 to about 12 U.S. perms (at 73° F.-50% RH via ASTM E96 procedure B), and a liquid water transmission rate from about 1 to about 28 (grams/100 in²/24 hr. via Cobb ring), per ASTM D5795.

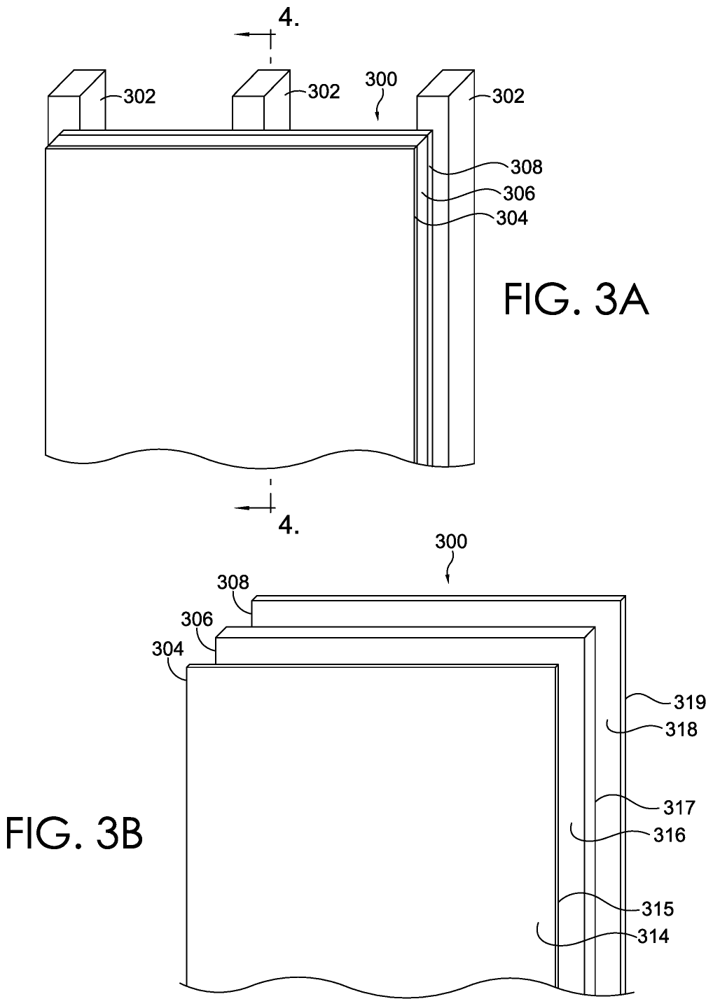

Turning now to FIG. 3A and FIG. 3B, a sheathing system 300 is illustrated having at least three layers. At a high level, the sheathing system 300 comprises the sheathing system 100 of FIGS. 1A-2B with the addition of a second structural layer 308; that is, the sheathing system 300 comprises a first structural layer 304, an insulation layer 306, and a second structural layer 308 (i.e., a “3-layer sheathing system”). Accordingly, the sheathing system 300 and each of the first structural layer 304 and the insulation layer 306 can have any one or more characteristics of the sheathing system 100, the structural layer 104, and the insulation layer 106, respectively, as described in relation to FIGS. 1A-2B. Additionally, the second structural layer 308 can have any one or more characteristics of the structural layer 104, as described in relation to FIGS. 1A-2B.

The inclusion of both a first structural layer 304 and a second structural layer 308 can be advantageous as it provides weather resistance to both sides of the insulation layer 306. Additionally, with brief reference to FIG. 11C, the first structural layer 304 and the second structural layer 308 can provide improved racking resistance over a single structural layer. Other design and structural requirements for a particular intended use can make it advantageous to have a second structural layer rather than a single structural layer.

Looking back now to FIGS. 3A and 3B, examples of the sheathing system 300 are illustrated in accordance with an exemplary aspect hereof. As shown in FIG. 3B, the sheathing system 300 comprises a fourth surface 317 of the insulation layer 306 and a third surface 316 of the insulation layer 306 opposite the fourth surface 317. A thickness of the insulation layer 306 can be measured as a distance from the third surface 316 to the fourth surface 317. Further, the first structural layer 304 comprises a second surface 315 and a first surface 314 opposite the second surface 315. A thickness of the first structural layer 304 can be measured as a distance from the first surface 314 to the second surface 115. Additionally, the second structural layer 308 comprises a sixth surface 319 and a fifth surface 318 opposite the sixth surface 319. A thickness of the second structural layer 308 can be measured as a distance from the fifth surface 318 to the sixth surface 319.

The sheathing system 300 is formed by coupling the second surface 315 of the first structural layer 304 to the third surface 316 of the insulation layer 306. Additionally, the fourth surface 117 of the insulation layer 306 is coupled to the fifth surface 318 of the second structural layer 308. More specifically, the first structural layer 304 can be coupled to the insulation layer 306 by bonding, adhering, applying, or mechanically fastening one layer to the other. Additionally, the second structural layer 308 can be coupled to the insulation layer 306 by bonding, adhering, applying, or mechanically fastening one of the layers to the other. By way of example, the sheathing system 300 can be formed by applying a glue layer or adhesive to the second surface 315 of the first structural layer 304 or the third surface 316 of the insulation layer 306 and adhering one surface to the other. By way of further example, the sheathing system 300 can be formed by applying a glue layer or adhesive to the fourth surface 317 of the insulation layer 306 or the fifth surface 318 of the second structural layer 308 and adhering one surface to the other.

As discussed in regard to other aspects described herein, the ratio of thickness of the first structural layer 304 and the second structural layer 308 relative to the thickness of insulation layer 306 can vary based on an intended use of the disclosed sheathing system. For example, when greater structural strength is desired, such as in areas prone to high winds or seismic forces, the combined thickness of the first structural layer 304 and the second structural layer 308 can increase as a proportion of the overall thickness of the sheathing system, or the thickness as measured from the first surface 314 to the sixth surface 319. In a further example, when greater insulation is desired and strength can be sacrificed, such as in less temperate climates, the insulation layer can be a greater proportion of the overall thickness. In a preferred arrangement, the ratio of insulation layer 306 thickness relative to the combined thickness of the first structural layer 304 and the second structural layer 308 can be about 3:1. In an embodiment, a sheathing system 300 can have a ratio of insulation layer 306 thickness relative to a combined thickness of the first structural layer 304 and the second structural layer 308 of about 3:1 and an overall thickness of 1 inch. This embodiment would have a combined thickness of the first structural layer 304 and the second structural layer 308 of ¼ inch and a thickness of the insulation layer 306 of ¾ inch. In some other embodiments, the ratio of insulation layer 306 thickness relative to a combined thickness of the first structural layer 304 and the second structural layer 308 can be 6:1, 5:1, 4:1, 2:1, 1.5:1, or 1:1, by way of non-limiting example. Additional ratios can be contemplated.

The purpose of the first structural layer 304 and the second structural layer 308 is to provide rigidity and structural support to the envelope of a building structure. Additionally, the material used for the first structural layer 304 and the second structural layer 308 can provide for other physical properties based on the intended use. For example, according to one or more design constraints, the sheathing system 300 can be spaced to have a particular external texture, weight, or other physical property. For example, in one embodiment the sheathing system 300 can require superior racking resistance due to high seismic activity. Additionally, the sheathing system 300 can require a particular texture, nail withdrawal force, or other physical properties to aid in the building envelope. Accordingly, the first structural layer 304 and the second structural layer 308 can be comprised of any one or more materials that resist racking forces, are lightweight, have one or more textures, resist nail withdrawal, or provide other desired physical properties. In one embodiment, both the first structural layer 304 and the second structural layer 308 can comprise the same material. In an alternative embodiment, if different physical properties are desired for the first structural layer 304 and the second structural layer 308, they can each be formed from different materials.

As described above, the first structural layer 304 and the second structural layer 308 can have differing physical requirements and thus can have differing thicknesses. In one example, the first structural layer 304 can be exposed to external impact forces and can require a thicker material to resist such an impact. Alternatively, the second structural layer 308 may not require such impact resistance and can thus be thinner than the first structural layer 304. As such, the first structural layer 304 can have a thickness in a range of 1/64 inch and 1 inch. The second structural layer 308 can have a thickness in a range of 1/64 inch and 1 inch. The insulation layer 306 can have a thickness in a range of ¼ inch and 1½ inches. The combined thickness of the first structural layer 304, the insulation layer 306, and the second structural layer 308 can be in a range of ½ inch and 2 inches. In an exemplary configuration, the thickness of the first structural layer 304, the insulation layer 306, and the second structural layer 308 is equal to or less than 1 inch, having an R-value of 5 or greater. Furthermore, alternative embodiments have an R-value-to-thickness ratio of at least 5, resulting in a 2-inch system with an R-value of 10.

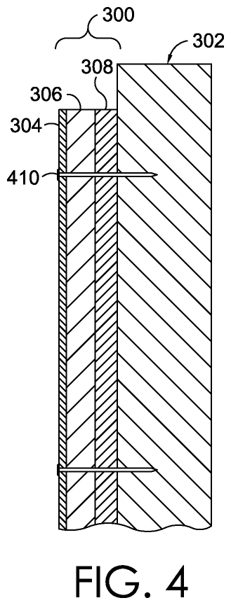

Looking now to FIG. 4, a cross-sectional view of sheathing system 300 of FIG. 3A along a cutline (4. of FIG. 3A) is depicted in accordance with aspects hereof. Sheathing system 300 comprises at least the insulation layer 306 adhered to the first structural layer 304 and the second structural layer 308. The sheathing system 300 can be fastened to the frame structure 302 by use of a fastener 410. The fastener 410 can comprise fasteners, such as nails, screws, or any other suitable fastener known in the art. In one embodiment, the distance from an exterior-facing or outer surface of the first structural layer 304 to an inner-facing or inner surface of the second structural layer 308 that is adjacent the frame structure 302 (i.e., the thickness of sheathing system 300) is one inch or less and has an R-value of 5 or greater. In another embodiment, the distance from the outer surface of the first structural layer 304 to the inner surface adjacent the frame structure 302 is 1.5 inches or less and an R-value of 7.5 or greater. In yet another embodiment, the distance from the outer surface of the first structural layer 304 to the inner surface adjacent the frame structure 302 is not greater than two inches.

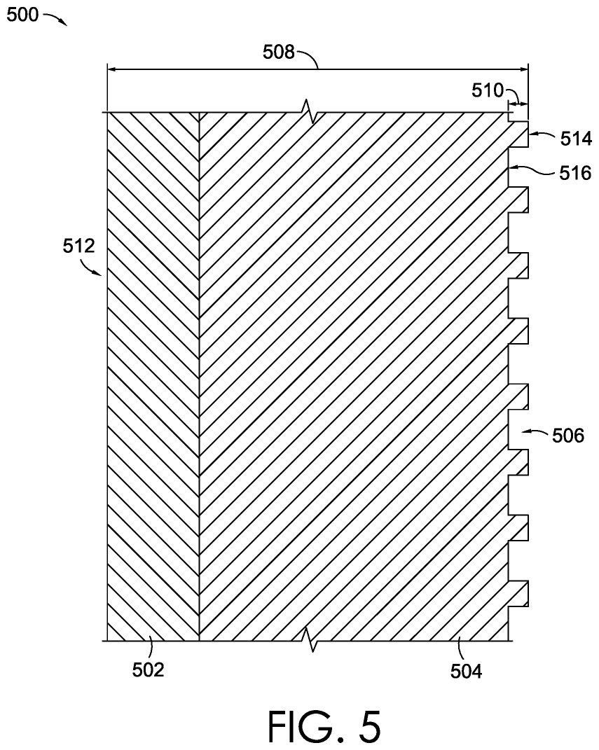

Turning now to FIG. 5, FIG. 5 depicts a cross-section of a top-down view of an embodiment of sheathing system 500, prior to installation. The sheathing system 500 is illustrated having drainage channels or grooves to prevent moisture buildup. At a high level, the sheathing system 500 comprises the sheathing system 100 of FIGS. 1A-2B with the addition of a plurality of drainage groves 506; that is, the sheathing system 500 comprises a structural layer 502, an insulation layer 504, and the plurality of moisture drainage grooves 506. Accordingly, the sheathing system 500 and each of the structural layer 502 and the insulation layer 504 can have any one or more characteristics of the sheathing system 100, the structural layer 104, and the insulation layer 106, respectively, as described in relation to FIGS. 1A-2B. The plurality of drainage grooves 506 can be recessed within (or extend from) the insulation layer 504. The offset or recess distance formed by the drainage grooves 506 is depicted by a distance 510 that extends from a recess surface 516 to an outer surface 514 of the insulation layer 504. The distance 510 being in a range from 0.01 inches to 0.1 inches. In an embodiment, a distance 508 from an outer structural surface 512 to the outer insulation surface 514 is in a range from about one inch to about two inches.

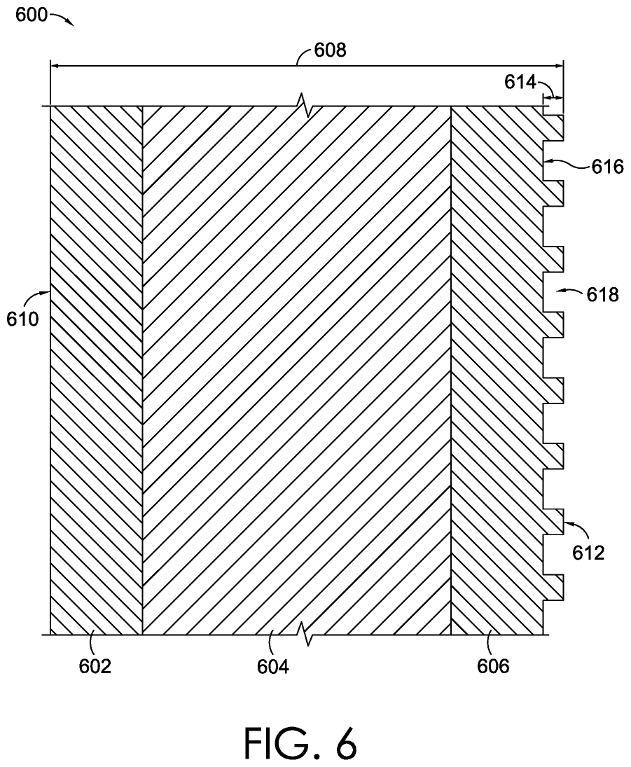

FIG. 6 similarly depicts a cross-section of a top-down view of a sheathing system 600, comprising a first structural layer 602, an insulation layer 604, and a second structural layer 606. In addition, the second structural layer 606 can contain moisture drainage grooves 618. The insulation layer 604, the first structural layer 602, and the second structural layer 606 can include any of the properties previously described with respect to, for example, FIG. 3A, FIG. 3B, and FIG. 4. Accordingly, for the sake of brevity, a detailed description of insulation layer 604, the first structural layer 602, and the second structural layer 606 will not be repeated with respect to the sheathing system 600 illustrated in FIG. 6.

The drainage grooves 618 can be recessed within (or extend from) the second structural layer 606. The offset or recess distance formed by the drainage grooves 618 is depicted by a distance 614 that extends from a recess surface 616 to an extension surface 612 of the second structural layer 606. The distance 614 from the recess surface 616 to the extension surface 612 being in a range from 0.01 inches to 0.1 inches. In one embodiment, a distance 608 from an outer first structural layer surface 610 to the extension surface 612 is one inch or less. In additional embodiments, the number of drainage grooves 618 per foot of sheathing system 600 can be in a range from 1 drainage groove per foot to 12 drainage grooves per foot.

Similar to drainage grooves 508 described in FIG. 5, drainage grooves 618 are designed on the surface of the sheathing system 600 such that gravity allows for the drainage of water from the sheathing system 600. The drainage grooves 618 create pathways that guide water away from sheathing system 600 and away from the building envelope. The sheathing system 600 can comprise a series of drainage grooves 618 arranged vertically such that as water or moisture encounters the drainage grooves 618, gravity pulls the water down and away from the building envelope. In one embodiment, drainage grooves 618 can take the form of a square groove as depicted in FIG. 6. In an additional embodiment, drainage grooves 618 are V-shaped grooves, rectangular grooves, or curved grooves. Additional shapes can be contemplated for use as the drainage grooves 618.

The arrangement of drainage grooves 618 can be vertical in orientation such that water flows directly down. Additionally, the drainage grooves 618 may be oriented in a horizontal arrangement or parallel to the ground when the sheathing system 600 is installed. In a further embodiment, the drainage grooves 618 can be oriented in a diagonal arrangement, a radial arrangement, or a serpentine arrangement.

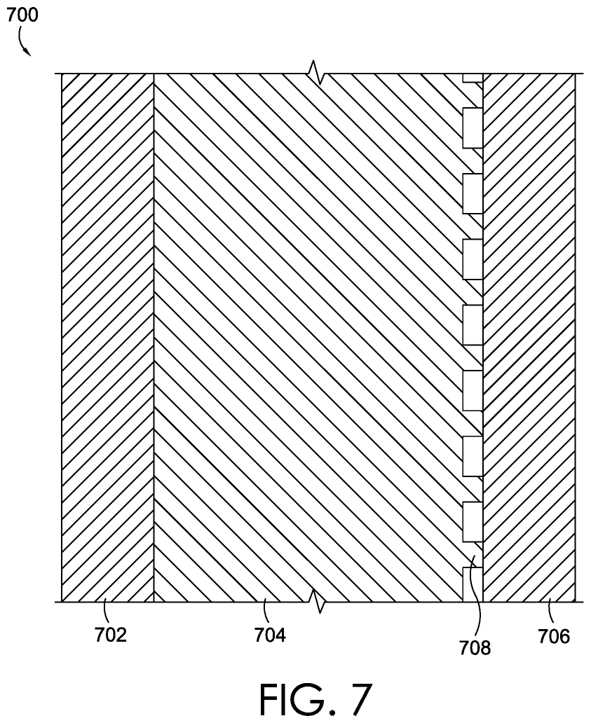

Looking now to FIG. 7, FIG. 7 depicts a cross-section of a top-down view of a sheathing system 700 comprising a first structural layer 702, an insulation layer 704, and a second structural layer 706. In the illustrated embodiment, the insulation layer 704 contains drainage grooves 708, which allow moisture to flow between the second structural layer 706 and the insulation layer 704. The insulation layer 704, the second structural layer 706, and the first structural layer 702 can include any of the properties previously described with respect to, for example, FIG. 3A, FIG. 3B and FIG. 4. Accordingly, for the sake of brevity, a detailed description of insulation layer 704, second structural layer 706, and first structural layer 702, will not be repeated with respect to the sheathing system 700 illustrated in FIG. 7.

Similar to the drainage grooves 618 described with respect to FIG. 6, drainage grooves 708 are designed as part of the sheathing system 700 such that the force of gravity allows for the drainage of water from the sheathing system 700. As shown in FIG. 7, the drainage grooves 708 are part of the insulation layer 704 as a space between the insulation layer 704 and the second structural layer 706. The placement of the drainage grooves 708 allows for the extraction of any moisture that is between the insulation layer 704 and the second structural layer 706. The drainage grooves 708 create pathways that guide water away from sheathing system 700, away from the insulation layer 704, and away from the building envelope. The sheathing system 700 can comprise a series of drainage grooves 708 arranged vertically such that as water or moisture encounters the drainage grooves 708, gravity pulls the water down and away from the insulation layer 704. In one embodiment, drainage grooves 708 can take the form of a square groove as depicted in FIG. 7. In an additional embodiment, drainage grooves 708 are V-shaped grooves, rectangular grooves, or curved grooves.

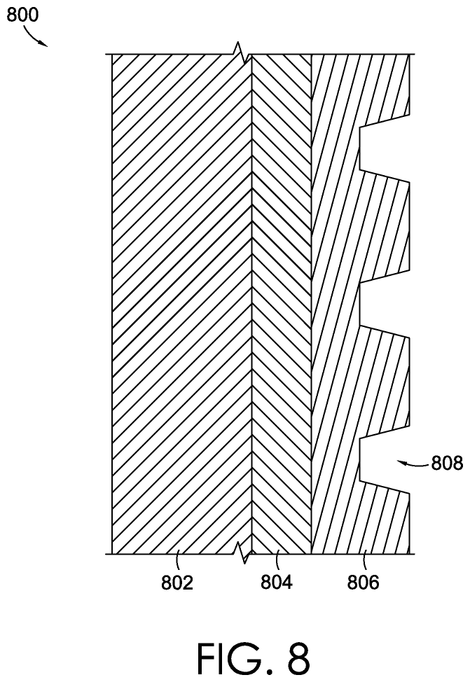

Continuing now with reference to FIG. 8, a cross-section of a top-down view of an embodiment of a sheathing system 800 is shown. The sheathing system 800 comprises a first structural layer 802, an insulation layer 804, a second structural layer 806, and drainage grooves 808. The drainage grooves 808 provide a varied cross section with non-perpendicular surfaces. The pattern of the drainage grooves 808 are designed to improve flow of moisture next to the sheathing system 800 for eventual extraction from the sheathing system altogether. The insulation layer 804, the second structural layer 806, and the first structural layer 802 can include any of the properties previously described with respect to, for example, FIG. 3A, FIG. 3B and FIG. 4. Accordingly, for the sake of brevity, a detailed description of insulation layer 804, second structural layer 806, and first structural layer 802, will not be repeated with respect to the sheathing system 800 illustrated in FIG. 8.

Drainage grooves 808 are designed similar to drainage grooves 618 of FIG. 6. As part of the sheathing system 800, drainage grooves 808 allow gravity to cause the drainage of water from the sheathing system 800. The drainage grooves 808 create pathways that guide water away from sheathing system 800 and away from the building envelope. As shown in FIG. 8, the drainage grooves 808 can have surfaces that deviate from the perpendicular.

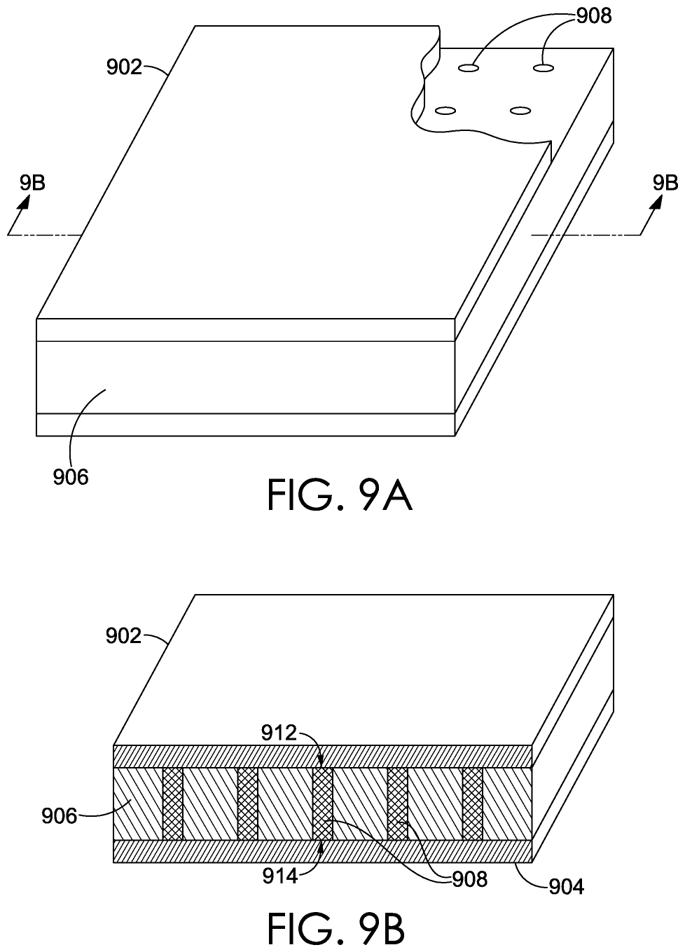

Alternative embodiments for coupling a first structural layer 902, an insulation layer 906, and a second structural layer 904 are depicted in FIGS. 9A and 9B. With specific reference to FIG. 9A, a perspective view of a sheathing system 900 is shown, which comprises a first structural layer 902, a second structural layer 904, an insulation layer 906, and one or more rods 908. The illustration of FIG. 9A has a cutout portion of the first structural layer 902 exposing the rods 908 for purposes of illustration only. In one embodiment, the rods 908 extend from the first structural layer 902 through the insulation layer 906 to the second structural layer 904. In some aspects, the rods 908 can take the form of a cylinder, a plane, a prism, a bar, or other shape that can connect the first structural layer 902 and the second structural layer 904 together.

Turning now to FIG. 9B, FIG. 9B depicts a cross section of the sheathing system 900 that incorporates the rods 908, the first structural layer 902, and the second structural layer 904. The rods 908 in the sheathing system 900 can be made of high-strength and heat-resistant polymers. Various polymer materials can be utilized for the rods, depending on the specific requirements of the sheathing system 900. For instance, engineering thermoplastics, such as nylon (e.g., nylon 6 or nylon 6/6), polypropylene, polycarbonate, or polyethylene terephthalate (PET) can be suitable options for the rods 908.

In an additional embodiment, to fuse the sheathing system 900 together, a melting process can be used to secure the rods 908 to the first structural layer 902 and the second structural layer 904. Additionally, the rods 908 can comprise thermoplastic materials, wherein rods 908 can be softened and fused during the assembly process. The melting process or a fusing process can involve the application of heat to the rods 908, causing them to soften and melt slightly. The rods 908 can penetrate the first structural layer 902, the second structural layer 904, and the insulation layer 906, filling any gaps or voids between them. As the molten rods 908 cool and solidify, they create a strong bond and form a fused connection, permanently securing the first structural layer 902 and the second structural layer 904 together at ends 912 and 914.

In some embodiments, a melting process can be achieved through various methods. One approach is to use heated metal plates or heated molds that are pressed against the first structural layer 902 and the second structural layer 904. The heat from the plates or molds transfers to the rods 908 at ends 912 and 914, causing them to melt and fuse with the first structural layer 902 and the second structural layer 904. Alternatively, localized heat sources, such as hot air or infrared heating, can be directed at specific areas where the rods 908 are inserted, enabling selective melting and fusion.

In other embodiments, the sheathing system 900 can comprise rods 908 made of metal, which provide a robust and durable solution for connecting the first structural layer 902, the second structural layer 904, and the insulation layer 906. Metal rods offer high strength, rigidity, and resistance to various environmental conditions. Metals utilized for this purpose include stainless steel, aluminum, or steel alloys.

In some other embodiments, the rods 908 can have various diameters and lengths to accommodate different panel sizes and design requirements. The ends 914 and 912 of the rods can be threaded, allowing them to be easily inserted and securely fastened to the structural layers. Alternatively, the rods 908 can be designed with enlarged heads or flanges that mechanically lock into the outer surfaces of the layers, providing a secure connection without the need for additional fasteners.

In an additional embodiment, the rods 908 can have a flanged or enlarged portion on the ends 914 such that the rods 908 holds the insulation layer 906 to the second structural layer 904. The rods 908 can then be connected to the first structural layer 902 and the second structural layer 904 by means of melting, fusing, or other means.

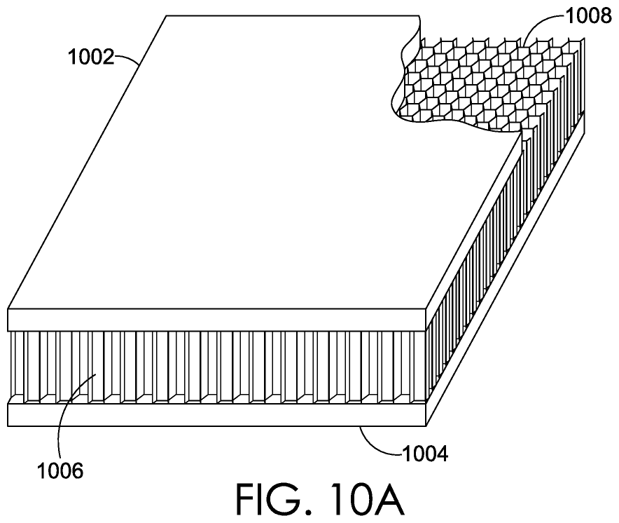

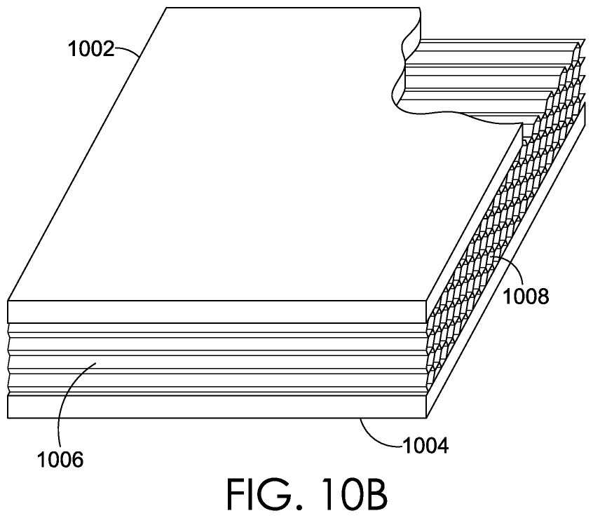

Turning now to FIG. 10A and FIG. 10B, which depict cross-sectional views of the sheathing system 1000. The sheathing system 1000 in FIG. 10A and FIG. 10B comprises a first structural layer 1002, a second structural layer 1004, and a support layer 1006. The first structural layer 1002 and the second structural layer 1004 may have any of the characteristics of the first structural layer 304 and the second structural layer 308, respectively, as previously described in relation to FIG. 3A, FIG. 3B, and FIG. 4. Accordingly, for the sake of brevity, a detailed description of the first structural layer 1002 and the second structural layer 1004 will not be repeated with respect to the sheathing system 1000 illustrated in FIG. 10A and FIG. 10B.

Between the first structural layer 1002 and the second structural layer 1004 is support layer 1006. The support layer 1006 comprises a series of walls or structures that separate the first structural layer 1002 and the second structural layer 1004. As shown in FIG. 10A, the support layer 1006 can have a series of walls that extend perpendicular from the first structural layer 1002 to the second structural layer 1004. The support layer 1006 creates elongated hexagonal spaces or void portions that extend from the first structural layer 1002 to the second structural layer 1004, such as insulation void portion 1008. As an example, the support layer 1006 comprises walls that extend from the first structural layer 1002 to the second structural layer 1004 creating insulation void portion 1008. The insulation void portion 1008, as shown in FIG. 10A can be oriented such as to extend from the first structural layer 1002 and the second structural layer 1004. In another embodiment, as shown in FIG. 10B, the support layer 1006 can have a series of structures that extend from the first structural layer 1002 to the second structural layer 1004. The support layer 1006 creates elongated hexagonal spaces or void portions that are parallel with the first structural layer 1002 and the second structural layer 1004, such as insulation void portion 1008. The insulation void portion 1008, as shown in FIG. 10B can be oriented parallel to the first structural layer 1002 and the second structural layer 1004.

The support layer 1006 can be comprised of any material that may be used or formed into a wall or support structure. For example, the support layer 1006 can be comprised of polycarbonate, polyurethane, metal, wood, or any other structurally supportive material, as required by the intended use of the support layer 1006.

The insulation void portion 1008 refers to the space or cavity created by the support layer 1006 of the sheathing system 1000. The insulation void portion 1008 can be filled with insulation material to ensure that the insulation material is properly contained within the panel. In some embodiments, the insulation material can comprise various insulating substances such as foam, fiberglass, or polymer-based insulation. The insulation void portion 1008 can be filled using spray foam, polyisocyanurate, EPS, recycled XPS, XPS, or other insulation materials. These materials can be sprayed, poured, or stuffed into the insulation void portion 1008. As can be seen in FIG. 10A, with the insulation void portion 1008 perpendicular to the first structural layer 1002 and the second structural layer 1004, the insulation void portion 1008 can be filled when one or more of the structural layers is not secured to the sheathing system 1000. However, as can be seen in FIG. 10B, having the insulation void portion 1008 parallel to the first structural layer 1002 and the second structural layer 1004, the insulation void portion 1008 can be filled when the sheathing system 1000 is completely assembled.

In some embodiments, the support layer 1006 in the sheathing system 1000 can be designed with a honeycomb pattern, creating a series of interconnected, hexagonal-shaped cells or chambers that form a regular and uniform structure throughout the support layer. A plurality of hexagonal cells or chambers created by the support layer 1006 produces a network of interconnected walls that distribute applied loads and stresses evenly across the sheathing system 1000, improving its structural integrity. As shown in FIG. 10A, the hexagonal cells or insulation void portion 1008 can be oriented such that the openings of the insulation void portion 1008 are adjacent to or facing the first structural layer 1002 and the second structural layer. Additionally, as shown in FIG. 10B, the hexagonal cells or insulation void portion 1008 can be oriented such that the openings of the insulation void portion 1008 are perpendicular to the first structural layer 1002 and the second structural layer.

In addition to the honeycomb pattern, in is contemplated that various other patterns can be employed in the support layer 1006 of the sheathing system 1000. These patterns offer different structural characteristics and can be selected based on specific design requirements and desired performance attributes. Other patterns can include, for instance: a square grid pattern with a series of interconnected square cells that form a grid-like structure; a triangular truss pattern that consists of interconnected triangular cells that create a truss-like framework; a diamond pattern that features interconnected diamond-shaped cells that form a repeating pattern; or a hexagonal grid pattern that, similar to the honeycomb pattern, consists of interconnected hexagonal cells. However, unlike the honeycomb pattern, the hexagonal grid does not form a continuous network of cells but rather a grid-like arrangement. In another embodiment, the support layer 1006 may include a random pattern that is a non-repetitive arrangement of cells or voids. The support layer can be designed with varying sizes and shapes of voids, providing flexibility in material distribution and load-bearing capabilities.

The inventive concepts have been described above both generically and with regard to various exemplary embodiments. Although the general inventive concepts have been set forth in what is believed to be exemplary illustrative embodiments, a wide variety of alternatives known to those of skill in the art can be selected within the disclosure. Additionally, the following data related to embodiments described herein are meant to better illustrate the present invention, but do in no way limit the general inventive concepts of the present invention.

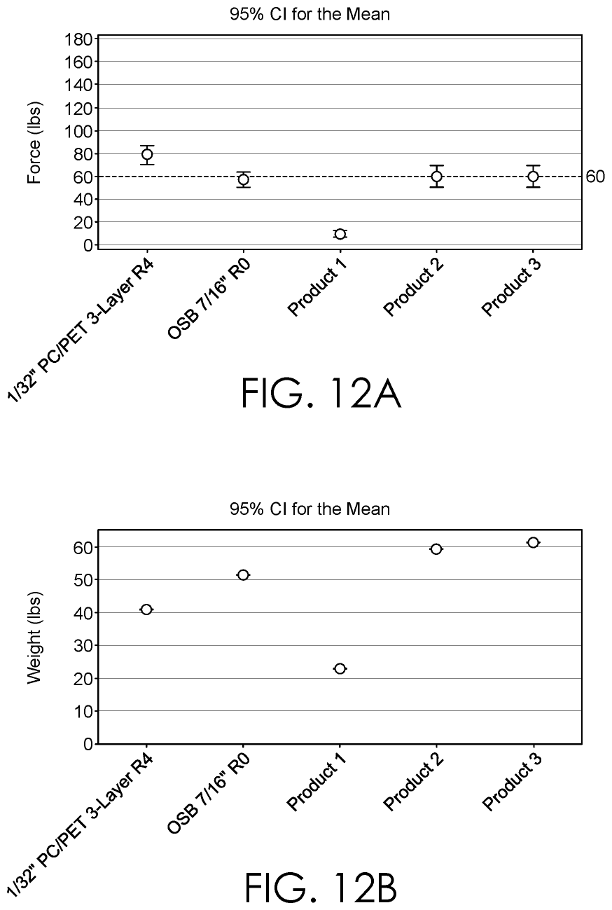

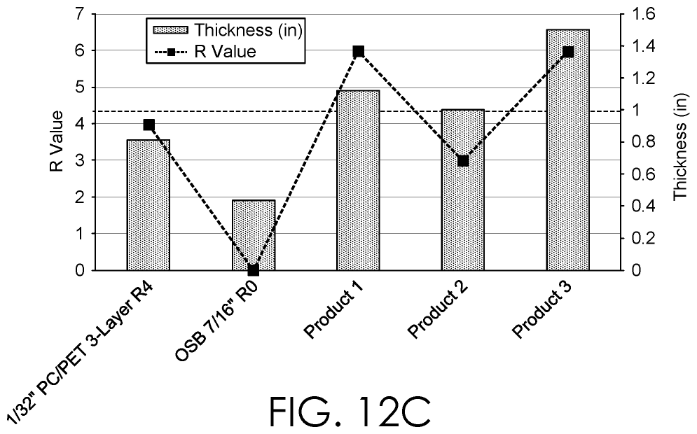

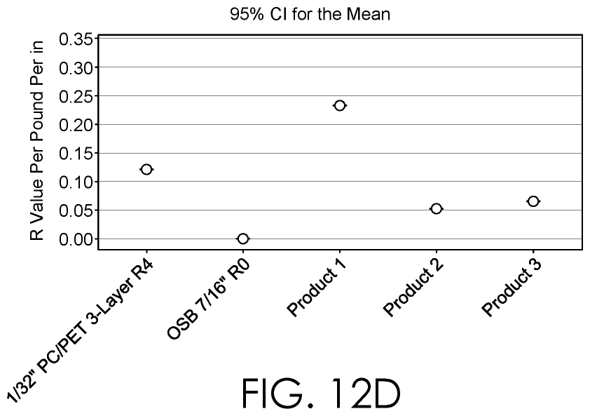

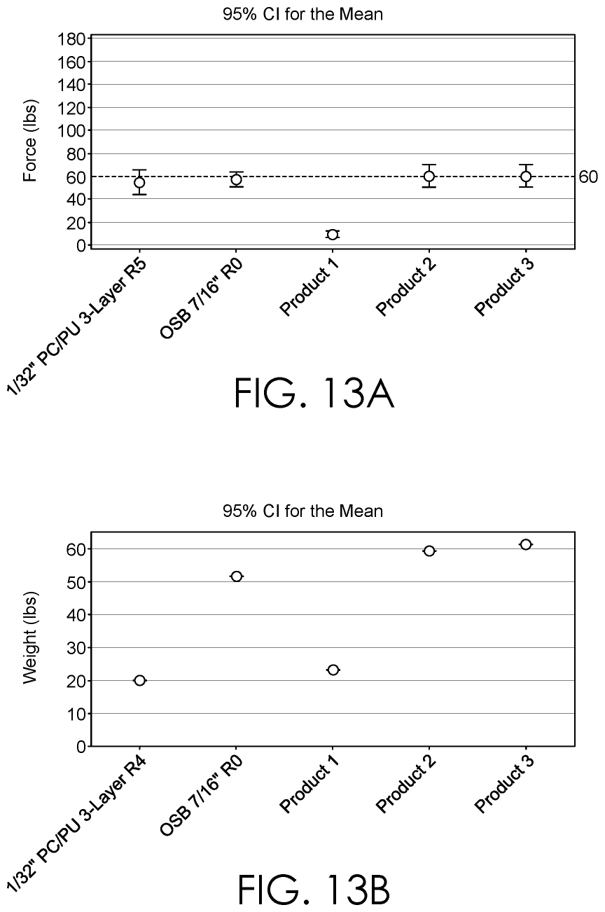

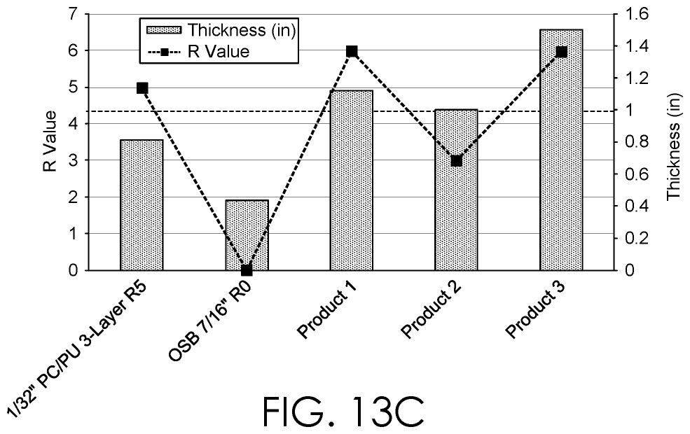

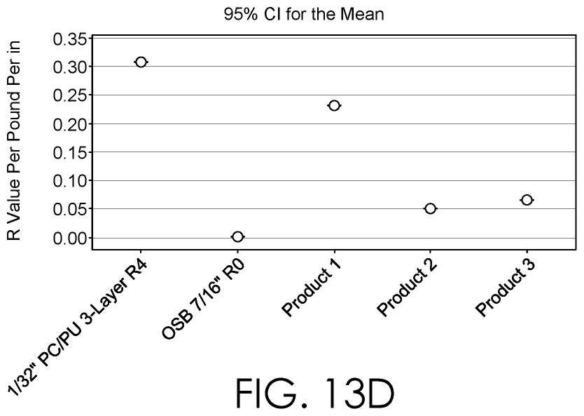

FIG. 11A through FIG. 13D depict data relating to embodiments of a 2-layer sheathing system (i.e., a structural layer and an insulation layer) and/or a 3-layer sheathing system (i.e., a first structural layer, an insulation layer, and a second structural layer), as previously described with respect to, for example, FIGS. 1A-2B and FIGS. 3A-4, respectively. In particular, FIGS. 11A-11G illustrate data relating to a 2-layer sheathing system and/or a 3-layer sheathing system, wherein the structural layer or layers comprise polycarbonate (PC) and the insulation layer comprises extruded polystyrene (XPS) (e.g., “ 1/16 inch PC/XPS 3-Layer R5”). FIGS. 12A-12D illustrate data relating to a 2-layer sheathing system and/or a 3-layer sheathing system, wherein the structural layer or layers comprise polycarbonate (PC) and the insulation layer comprises polyethylene terephthalate (PET) (e.g., “ 1/16 inch PC/PET 3-Layer R5”). FIGS. 13A-13D illustrate data relating to a 3-layer sheathing system, wherein the structural layers comprise polycarbonate (PC) and the insulation layer comprises polyurethane (PU) (e.g., “ 1/32 inch PC/PU 3-Layer R5”).

Moreover, FIGS. 11A-13D illustrate embodiments of a 2-layer sheathing system and/or a 3-layer sheathing system wherein the thickness or width of each structural layer may vary between 1/16 inch, 1/32 inch, or ⅛ inch for an overall sheathing system thickness or width of one (1) inch or less. For example, the embodiment identified as “ 1/16” PC/XPS 3-Layer R5″ refers to a 3-layer sheathing system having a first structural layer and a second structural layer, each structural layer comprising polycarbonate and each having a thickness of 1/16 inch, and an XPS insulation layer having a thickness of ¾ inch.

Additionally, FIG. 11A through FIG. 13D include comparative data with industry standard sheathing systems identified as “OSB,” “Product 1”, “Product 2,” and “Product 3.” “OSB” refers to industry standard wall sheathing comprised of oriented strand board panel having a thickness of 7/16 inch. “Product 1” refers to a prior wall sheathing system including a thermoply structural layer, a polyisocyanurate layer, a facer, and a thickness of 1 and ⅛ inch. “Product 2” and “Product 3” refer to prior wall sheathing systems including an OSB layer and a layer of polyisocyanurate insulation in varying thicknesses to achieve different levels of insulation.

The representative data shown in FIG. 11A through FIG. 13D demonstrate the superior capabilities of the sheathing system embodiments described herein. As evident, the currently disclosed sheathing system outperforms the current industry standard products in most categories and performs better overall than industry standard products.

FIG. 11A through FIG. 11G depict data related to a 2-layer sheathing system and/or a 3-layer sheathing system, wherein the insulation layer comprises extruded polystyrene (XPS) and the structural layer or layers comprise polycarbonate (PC). FIG. 11A shows data relating to a nail pull or withdrawal test conducted in accordance with ASTM D1037 standards. The nail pull test is used to assess the resistance of fasteners in materials. During the test, a nail is driven into the material under investigation, and the force required to pull the nail out of the material is measured. The data depicted in FIG. 11A demonstrates superior performance of several of the embodiments described herein to current industry standard products. The currently disclosed sheathing system has a nail withdrawal force between 20 lbs. and 200 lbs. Additionally, the currently disclosed sheathing system has a preferable nail withdrawal force between 50 lbs. and 200 lbs. In a further preferable embodiment, the currently disclosed sheathing system has a nail withdrawal force between 120 lbs. and 200 lbs. In contrast, the industry standard sheathing system exhibited a nail withdrawal force of less than 60 lbs. For example, as illustrated, the 1/16 inch PC/XPS 3-Layer R5 sheathing system and the ⅛ inch PC/XPS 2-Layer R5 sheathing system provided a mean nail withdrawal force of 140 lbs. and 165 lbs., respectively. In comparison, the OSB sheathing panel, Product 2 and Product 3 each provided a mean nail withdrawal force of approximately 60 lbs. Product 1, a wall sheathing system including a thermoply structural layer, a polyisocyanurate layer, a facer, and a thickness of 1 and ⅛ inch, exhibited a mean nail withdrawal force of less than 15 lbs.

FIG. 11B and FIG. 11C describe data related to a series of tests performed to measure the structural performance and assess the resistance of the embodied sheathing system against lateral forces, such as those experienced during seismic events or strong wind conditions. FIG. 11B used ASTM E72 standards and FIG. 11C used ASTM E564 standards to measure the racking performance of each panel. This data shows superior performance of the embodied panels compared to the current sheathing systems. The currently disclosed sheathing system provides a racking strength greater than 440 plf. In a preferred embodiment, the disclosed sheathing system provides a racking strength greater than 475 plf. In an additional preferred embodiment, the disclosed sheathing system has a racking strength greater than 700 plf. The 1/16 inch PC/XPS 3-layer panel has a mean racking strength max force of 760 plf. using the ASTM E72 method and 805 plf. using the ASTM E564 method. The 1/32 inch PC/XPS 3-layer panel has a mean racking strength max force of 780 plf. using the ASTM E72. The ⅛ inch PC/XPS 2-layer panel has a mean racking strength max force of 795 plf. using the ASTM E72 method and 790 plf. using the ASTM E564 method. In comparison, each of the industry standard products show significantly lower racking strength max forces indicating the current embodiment's superior racking performance. OSB has a mean racking strength max force of 680 plf. using the ASTM E72 method and 645 plf. using the ASTM E564 method. Product 1 has a mean racking strength max force of 490 plf. using the ASTM E72 method and 600 using the ASTM E564 method. Product 2 has a mean racking strength max force of 610 plf. and Product 3 has a mean racking strength max force of 400 plf. using the ASTM E72 method.

FIG. 11D provides data that describes the weight of a 4 foot by 8 foot panel of each sheathing system tested. FIG. 11E describes the thickness and the corresponding R-value of the disclosed sheathing systems in comparison with the industry standard or prior sheathing systems. The currently disclosed sheathing system has a weight between 5 lbs. and 40 lbs. and a preferred weight of between 10 lbs. and 30 lbs. Further, the currently disclosed sheathing system has a thickness between 0.5 inches and 1.5 inches with a preferred thickness between 0.8 inches and 1.06 inches. Additionally, the currently disclosed sheathing system has an R-value between 2 and 9 with a preferred R-value between 3.5 and 6. As illustrated, the 1/16 inch PC/XPS 3-Layer R5 panel has a weight of 30 lbs. and a thickness of ⅞ inches. Further, the 1/32 inch PC/XPS 3-Layer R5 panel has a weight of 20 lbs. and a thickness of 13/16 inch. Additionally, the ⅛ inch PC/XPS 2-Layer R5 panel has a weight of 30 lbs. and a thickness of ⅞ inch. The OSB has a weight of 52 lbs. and a thickness of 7/16 inch, product 1 has a weight of 23 lbs. and a thickness of 17/16 inch, product 2 has a weight of 60 lbs. and a thickness of 1 inch, and product 3 has a weight of 62 lbs. and a thickness of 1.5 inches. As evident in FIGS. 11D and 11E, the currently disclosed embodiments are lighter per thickness than current standard products available, while still maintaining higher racking performance (see, for example, FIGS. 11B-11C).

FIG. 11E and FIG. 11F provide data related to the R-value of the disclosed sheathing systems in comparison with the industry standard or prior sheathing systems. For each of the polycarbonate sheathing system, the total thickness is less than one inch and the R-value is 5 or greater. The 1/16 inch PC/XPS 3-Layer R5 panel has an R-value of 5 and an R-value per pound per inch of 0.2. The 1/32 inch PC/XPS 3-Layer R5 panel has an R-value of 5 and an R-value per pound per inch of 0.32. The ⅛ inch PC/XPS 2-Layer R5 panel has an R-value of 5 and an R-value per pound per inch of 0.2. In contrast, the OSB has an R-value of 0 and an R-value per pound per inch of 0; Product 1 has an R-value of 6 and an R-value per pound per inch of 0.24; Product 2 has an R-value of 3 and an R-value per pound per inch of 0.05; and Product 3 has an R-value of 6 and an R-value per pound per inch of 0.07. As shown, the currently disclosed sheathing system has a higher R-value per pound per inch than industry standard sheathing systems, even while maintaining racking performance. Product 1 has comparable R-value per pound per inch but suffers significantly in racking performance. Thus, the current sheathing system embodiments are superior to current industry standard products.

As shown in FIG. 11G, the fire performance of the disclosed sheathing system in comparison with the industry standard or prior sheathing systems is shown. ASTM E84 was the test method used to assess the fire and smoke performance of building materials, specifically for interior wall and ceiling finishes. Also known as the “Standard Test Method for Surface Burning Characteristics of Building Materials,” the E84 test is commonly used to evaluate how materials behave when exposed to flame and how they contribute to the generation and spread of smoke. The currently disclosed sheathing system has a fire performance between 0 and 150 with a preferred fire performance of less than 20. For example, the PC/XPS 3-Layer panel has a flame E84 of 0. The 3-Layer ⅛ inch panel has a flame E84 of 10. In contrast, the OSB has a flame E84 of 150. Product 1 has a flame E84 of 75. Product 2 exhibited a flame E84 of 60 and Product 3 exhibited flame E84 of 60. The flame performance of the embodiments described herein exceed that of the industry standard products.

Moving on to FIG. 12A through FIG. 12D, the depicted data shows a 3-layer sheathing system, wherein the insulation layer comprises polyethylene terephthalate (PET) and the first structural layer and the second structural layer each comprise polycarbonate (PC). FIG. 12A depicts the results of the nail-pull test according to ASTM D1037, as previously described. As shown the currently disclosed sheathing system has a nail withdrawal force between 20 lbs. and 200 lbs. Additionally, the currently disclosed sheathing system has a preferable nail withdrawal force between 50 lbs. and 200 lbs. In contrast, the industry standard sheathing system exhibited a nail withdrawal force of approximately 60 lbs. Thus, the currently disclosed sheathing system has superior nail withdrawal than the industry standard or prior sheathing systems. For example, as illustrated, a 1/32 inch PC/PET 3-Layer R4 sheathing system has a mean nail withdrawal force of 80 lbs. Whereas, the OSB, Product 1, Product 2, and Product 3 all show a nail withdrawal of approximately 60 lbs.

The data shown in FIG. 12B corresponds to the weight of 4 foot by 8 foot sheathing systems tested. FIG. 12C shows the thickness and the corresponding R-value of the 3-layer sheathing system in comparison with the industry standard or prior sheathing systems. FIG. 12D shows the R-value per inch of the disclosed 3-layer sheathing system in comparison with industry standard or prior sheathing systems. As illustrated, the currently disclosed sheathing system may have a weight between 5 lbs. and 40 lbs. and a preferred weight of between 10 lbs. and 30 lbs. Further, the currently disclosed sheathing system provides a thickness between 0.5 inches and 1.5 inches with a preferred thickness between 0.8 inches and 1.06 inches. Additionally, the currently disclosed sheathing system provides an R-value between 2 and 9 with a preferred R-value between 3.5 and 6. In contrast, significantly heavier (62 lbs) prior Product 2 with a thickness of one inch provides an R-value of 3. As evident, the current embodiments shown are lighter per thickness than industry standard products available, while providing a high R-value while maintaining racking performance. Product 1 has comparable R-value per pound per inch but suffers significantly in racking performance. Thus, the current embodiments are still far superior to the industry standard products.

Continuing on to FIG. 13A through FIG. 13D, the depicted data shows a 3-layer sheathing system, wherein the insulation layer comprises polyurethane (PU) and the first structural layer and the second structural layer each comprise polycarbonate (PC). As shown, the current sheathing system has a nail withdrawal force between 20 lbs. and 200 lbs. Additionally, the sheathing system has a preferable nail withdrawal force between 50 lbs. and 200 lbs. FIG. 13A depicts the results of the nail-pull test according to ASTM D1037, as described above. The 1/32 inch PC/PU 3-Layer R5 panel has a mean nail withdrawal force of 58 lbs. The 1/32 inch PC/PET 3-Layer R5 has a thickness of 13/16 inch thus the system has a mean nail withdrawal force required of 71 lbs. per inch. The OSB has a mean nail withdrawal force of 57 lbs. per inch. Product 1 has a nail withdrawal force of 9 lbs. per inch. Product 2 has a nail withdrawal force of 60 lbs. per inch and Product 3 has a mean nail withdrawal force of 60 lbs. per inch.

The results shown in FIG. 13B correspond to the weight of 4 foot by 8 foot sheathing systems tested. FIG. 13C shows the thickness and the corresponding R-value of the 3-layer sheathing system in comparison with the industry standard or prior sheathing systems. FIG. 13D shows the R-value per inch of the disclosed 3-layer sheathing system in comparison with industry standard or prior sheathing systems. As illustrated, the 3-layer sheathing system has a weight of 20 lbs., a thickness of 13/16 inch, an R-value of 5 and an R-value per pound per inch of 0.32. In comparison, the OSB has a weight of 52 lbs., a thickness of 7/16 inch, an R-value of 0 and an R-value per pound per inch of 0. Product 1 has a weight of 23 lbs., a thickness of 17/16 inch, an R-value of 6 and an R-value per pound per inch of 0.24. Product 2 has a weight of 60 lbs., a thickness of 1 inch, an R-value of 3 and an R-value per pound per inch of 0.05. Product 3 has a weight of 62 lbs., a thickness of 1.5 inches, an R-value of 6 and an R-value per pound per inch of 0.07. The current embodiments shown have a higher R-value per pound per inch than other sheathing systems, even while maintaining racking performance. Product 1 has comparable R-value per pound per inch but suffers significantly in racking performance. Thus, the current embodiments are far superior.

It will be understood that certain features and subcombinations are of utility and can be employed without reference to other features and subcombinations. This is contemplated by and is within the scope of the claims.

While specific elements and steps are discussed in connection to one another, it is understood that any element and/or steps provided herein is contemplated as being combinable with any other elements and/or steps regardless of explicit provision of the same while still being within the scope provided herein. Since many possible embodiments can be made of the disclosure without departing from the scope thereof, it is to be understood that all matter herein set forth or shown in the accompanying drawings is to be interpreted as illustrative and not in a limiting sense.

The invention claimed is:

1. A sheathing system to externally envelope at least a portion of a building structure, the sheathing system comprising:
a first structural layer having a first surface and a second surface opposite the first surface;
an insulation layer having a third surface and a fourth surface opposite the third surface, the third surface of the insulation layer being at least partially secured to the second surface of the first structural layer; and
a second structural layer having a fifth surface and a sixth surface opposite the fifth surface, the fifth surface of the second structural layer being at least partially secured to the fourth surface of the insulation layer,
wherein a distance from the first surface of the first structural layer to the sixth surface of the second structural layer is no greater than 1.5 inches and the sheathing system has an R-value of at least 3.5.

2. The sheathing system of claim 1, wherein the first structural layer comprises a polymer material, said polymer material comprising any one or more of polycarbonate, polyester, polypropylene, polymethyl methacrylate, poly vinyl chloride, high density polyethylene, and copolymers thereof.

3. The sheathing system of claim 1, wherein each of the second structural layer comprises a polymer material, said the polymer material comprising any one or more of polycarbonate, polyester, polypropylene, polymethyl methacrylate, poly vinyl chloride, high density polyethylene, and copolymers thereof.

4. The sheathing system of claim 1, wherein the first structural layer comprises a polymer composite having a polymer and one or more filler materials.

5. The sheathing system of claim 1, wherein the second structural layer comprises a polymer composite having a polymer and one or more filler materials.

6. The sheathing system of claim 1, wherein the insulation layer comprises any one or more of extruded polystyrene, expanded polystyrene, foamed polyurethane, polyisocyanurate, mineral wool, polyethylene terephthalate, polyester, phenolic foam, aerogel blanket, aerogel hoard, and polyurethane.

7. The sheathing system of claim 1, wherein the sheathing system has a nail withdrawal force between 20 pounds and 200 pounds.

8. The sheathing system of claim 1, wherein the sheathing system has a racking performance greater than 440 plf.

9. The sheathing system of claim 1, wherein the distance from the first surface of the first structural layer to the sixth surface of the second structural layer is no greater than 1.5 inches and the sheathing system has an R-value of at least 4.5.

10. The sheathing system of claim 1, wherein the distance from the first surface of the first structural layer to the sixth surface of the second structural layer is no greater than 1 inch and the sheathing system has an R-value of at least 3.5.

11. The sheathing system of claim 1, wherein the distance from the first surface of the first structural layer to the sixth surface of the second structural layer is no greater than 1 inch and the sheathing system has an R-value of at least 4.5.

12. The sheathing system of claim 1, wherein the sheathing system has a weight between 10 pounds to 45 pounds.

13. The sheathing system of claim 12, wherein the distance from the first surface of the first structural layer to the sixth surface of the second structural layer is no greater than 1.5 inches and the sheathing system has an R-value of at least 4.5.

14. A sheathing system to externally envelope at least a portion of a building structure and prior to securement to the building structure, the sheathing system comprising:
a structural layer having a first surface and a second surface opposite the first surface; and
an insulation layer having a third surface and an opposite fourth surface, the third surface of the insulation layer being at least partially secured to the second surface of the structural layer,
wherein the sheathing system has a first distance of no greater than 1.5 inches from the first surface of the structural layer to the opposite fourth surface of the insulation layer, wherein the sheathing system has an R-value of at least 3.5.

15. The sheathing system of claim 14, wherein the structural layer comprises any one or more of polycarbonate, polyester, polypropylene, polymethyl methacrylate, poly vinyl chloride, high density polyethylene, and copolymers thereof.

16. The sheathing system of claim 14, wherein the structural layer comprises a polymer composite having a polymer and one or more filler material.

17. The sheathing system of claim 14, wherein the insulation layer comprises any one or more of extruded polystyrene, expanded polystyrene, foamed polyurethane, polyisocyanurate, mineral wool, polyethylene terephthalate, polyester, phenolic foam, aerogel blanket, aerogel hoard, and polyurethane.

18. The sheathing system of claim 14, wherein the sheathing system has a racking performance greater than 440 plf.

19. The sheathing system of claim 1, wherein the distance from the first surface of the structural layer to the opposite fourth surface of the insulation layer is no greater than 1.5 inches and the sheathing system has an R-value of at least 4.5.

20. The sheathing system of claim 1, wherein the distance from the first surface of the structural layer to the opposite fourth surface of the insulation layer is no greater than 1 inch and the sheathing system has an R-value of at least 3.5.

21. The sheathing system of claim 1, wherein the distance from the first surface of the structural layer to the opposite fourth surface of the insulation layer is no greater than 1 inch and the sheathing system has an R-value of at least 4.5.

22. The sheathing system of claim 1, wherein the sheathing system has a weight between 10 pounds to 45 pounds.

23. The sheathing system of claim 22, wherein the distance from the first surface of the structural layer to the opposite fourth surface of the insulation layer is no greater than 1.5 inches and the sheathing system has an R-value of at least 4.5.
